(19) United States
(12) Patent Application Publication
(10) Pub. No.: US 2014/0258772 A1
(43) Pub. Date: Sep. 11, 2014

(54) UTILIZING BACKWARD DEFECT INDICATIONS IN Y-CABLE PROTECTION SWITCHING

(71) Applicant: FUJITSU LIMITED, Kanagawa (JP)

(72) Inventors: Deepak Kataria, Bridgewater, NJ (US); David Solomon, River Vale, NJ (US); Michael Green, Central Valley (NY); Nitin Gogate, Montvale, NJ (US); Junjie Chen, Cedar Knolls, NJ (US)

(73) Assignee: FUJITSU LIMITED, Kanagawa (JP)

(21) Appl. No.: 13/789,288

(22) Filed: Mar. 7, 2013

(51) Int. Cl. G06F 11/20

(52) U.S. Cl. CPC G06F 11/2005
USPC 714/4.11

(57) ABSTRACT

In accordance with teachings of the present disclosure, a method includes—at a network element communicatively coupled to a y-cable through two transmitters of the network element—transmitting data from a transmitter through the y-cable to a client and withholding transmission from the other transmitter, and determining whether receivers have received a backward defect indicator from the client. The method further includes determining that an interruption has occurred within a transmission media between the network element and the client, based on the determinations of whether the receivers have received the backward defect indicator from the client. The method also includes, based on the determination of the interruption, transmitting data from the other transmitter through the y-cable to the client and withholding transmission from the transmitter.

### TECHNICAL FIELD

The present disclosure is related to network communication systems, and more particularly, to utilizing backward defect indications in y-cable protection switching.

### BACKGROUND

Telecommunications systems, cable television systems, and data communication networks use optical networks to rapidly convey large amounts of information between remote points. In an optical network, information is conveyed in the form of optical signals through optical fibers. Optical fibers comprise thin strands of glass capable of communicating the signals over long distances with very low loss. Optical networks often employ redundancies to maximize performance and availability.

Defects may occur within network systems. The term defect may refer to any error, problem, situation, mechanical failure, electrical failure, hardware failure, or software failure which may negatively affect the ability of the network system to carry a signal. For example, a defect may be a break in an optical fiber that may disrupt the flow of a signal along its path.

Redundancy may be employed to provide some protection against defects. One example of redundancy is alternative paths for communication between two network nodes. In a system with multiple paths, one method of redundancy is to have a working path and a protect path. If some error or defect occurs on a working path that is active, the system may transition to using protect path to carry signals, making it the new active path. In a bi-directional switching scheme, if a defect or error is detected in either direction of communication, both directions of communication are switched from the working path to the protect path.

### SUMMARY

In accordance with teachings of the present disclosure, one embodiment includes a method including—at a network element communicatively coupled to a y-cable through two transmitters of the network element—transmitting data from a transmitter through the y-cable to a client and withholding transmission from the other transmitter, and determining whether receivers have received a backward defect indicator from the client. The method further includes determining that an interruption has occurred within a transmission media between the network element and the client, based on the determinations of whether the receivers have received the backward defect indicator from the client. The method also includes, based on the determination of the interruption, transmitting data from the other transmitter through the y-cable to the client and withholding transmission from the transmitter.

In another embodiment, a network includes transmitters communicatively coupled to a y-cable, a selector communicatively coupled to the transmitters and configured to selectively output data from either of the transmitters through the y-cable to a client, receivers configured to receive output from the client through the y-cable, and a switch management controller communicatively coupled to the selector and the receivers. The switch management controller is configured to determine whether the receivers have received a backward defect indicator from the client. Furthermore, the switch management controller is configured to, based on the determinations regarding receipt of the backward defect indicator, determine that an interruption has occurred within a transmission media between the network element and the client. In addition, based on the determination of the interruption, the switch management controller is configured to cause the selector to transmit data from the other transmitter through the y-cable to the client and withhold transmission from the transmitter.

In yet another embodiment, an article of manufacture includes a computer readable medium and computer-executable instructions carried on the computer readable medium. The instructions are readable by a processor. The instructions, when read and executed, cause the processor to—at a network element communicatively coupled to a y-cable through two transmitters of the network element—transmit data from a transmitter through the y-cable to a client and withholding transmission from the other transmitter, and determine whether receivers have received a backward defect indicator from the client. The processor is further caused to determine that an interruption has occurred within a transmission media between the network element and the client, based on the determinations of whether the receivers have received the backward defect indicator from the client. The processor is also caused to, based on the determination of the interruption, transmitting data from the other transmitter through the y-cable to the client and withholding transmission from the transmitter.

The object and advantages of the invention will be realized and attained by means of at least the features, elements, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 is an illustration of an example embodiment of a network;

FIG. 2 illustrates communication paths between a client and a network element;

FIGS. 3A, 3B, and 3C illustrate operation of a network to detect backward defect indications in y-cabling components;

FIG. 4 is an example embodiment of a state graph illustrating operation of a network element when experiencing failures in both standby and active transmission paths;

FIG. 5 illustrates an example embodiment of priority tables for handling backward defect indicators;

FIG. 6 illustrates an example embodiment of use cases for receipt of various messages on an active facility and a standby facility;

FIG. 7 is an illustration of an example embodiment of a method for performing backward defect detection in y-cabling; and

FIG. 8 is an illustration of an example embodiment of a method for handling prioritization of backward defect messages in combination with other protection switching messages.

### DETAILED DESCRIPTION

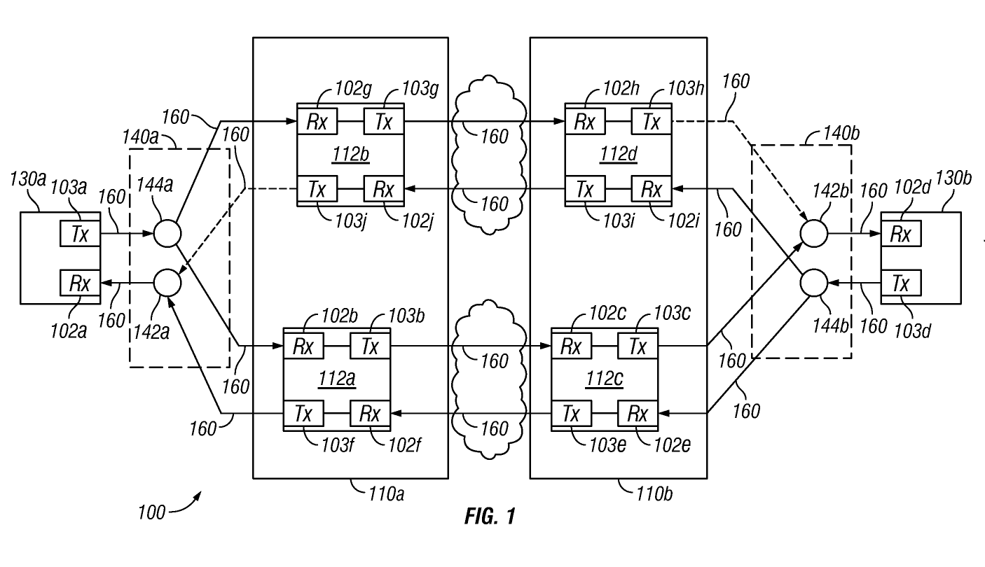

Embodiments of the present disclosure and its advantages are best understood by reference to FIGS. 1-8 wherein like numbers refer to same and like parts.

FIG. 1 is an illustration of an example embodiment of a network 100 in accordance with the present disclosure. Network 100 may be configured to provide backward defect detection in y-cabling components therein. Furthermore, network 100 may be configured to prioritize detected backward defects in relation to other messages regarding protection switching. In certain embodiments, network 100 may include a network configured to provide communication of packets and/or frames via synchronous optical networking (SONET). In other embodiments, network 100 may comprise a network configured to provide for Ethernet datagram communication via Optical Transport Network (OTN). In some embodiments, a client side of network 100 may use Ethernet, SONET, Fibre Channel, OTN, video signals, cable signals, digital signals, or any other signal able to be encapsulated in OTN or SONET. The client side of network 100 may be understood to include communication between a client 130 and a network element 110. In other embodiments, a network side of network 100 may use OTN or SONET. The network side of network 100 may be understood to include communication between network elements 110. Other embodiments may include any other suitable data communicated using any other suitable network protocol for network 100. Network 100 may include one or more transmission media operable to transport one or more signals communicated by components of network 100. The components of network 100, coupled together by transmission media 160, may include a plurality of network elements 110, for example, near network element 110a and far network element 110b. Network 100 may be used in a short-haul metropolitan network, a long-haul inter-city network, or any other suitable network or combination of networks. It will be appreciated that the terms “near” and “far” as used in this disclosure are merely for convenience and are in no way limiting or descriptive of an actual location. For example, the terms “near” and “far” might just as easily be substituted with “first” and “second,” and are merely used to facilitate understanding of the present disclosure.

Each transmission medium 160 may include any system, device, or apparatus configured to communicatively couple network elements 110 to each other, and/or clients 130, and communicate information between network elements 110 and clients 130. For example, a transmission medium 160 may include an optical fiber, an Ethernet cable, a T1 cable, a Wi-Fi signal, a Bluetooth signal, or other suitable medium. When the term receiver is used, it will be appreciated that this refers to any component operable to act as an interface between a transmission medium 160 and a network element 110 and/or client 130 and operable to receive a signal transmitted over a transmission medium 160. In like manner, a transmitter refers to any component operable to act as an interface between a transmission medium 160 and a network element 110 and/or client 130 and operable to transmit a signal over a transmission medium 160.

Network 100 may further communicate information or “traffic” over transmission media 160. As used herein, “traffic” means information transmitted, stored, or sorted in network 100. Such traffic may comprise optical or electrical signals configured to encode audio, video, textual, and/or any other suitable data. The data may also be real-time or non-real-time. Traffic may be communicated via any suitable communications protocol. Additionally, the traffic communicated in network 100 may be structured in any appropriate manner including, but not limited to, being structured in frames, packets, or an unstructured bit stream. As used herein, the term “datagram” may refer to a frame, packet, or other data structure for transmission of traffic.

Network 100 may further include any system configured to switch, forward, and/or route traffic between network elements 110. Network 100 may comprise a plurality of optical nodes each configured to provide switching, forwarding, and/or routing functionality.

It will be appreciated that network elements 110 in network 100, for example near network element 110a and far network element 110b, may comprise any suitable system operable to transmit and receive traffic. In the illustrated embodiment, the network elements 110 may be operable to transmit traffic directly to one or more other network elements 110 and receive traffic directly from the one or more other network elements 110. Further, network elements 110 may communicate to each other over any of a variety of paths over network 100. In certain embodiments, a network element 110 may perform datagram segmentation, reassembly, and other tasks in order to convert Ethernet packets received from clients 130 to frames (e.g., SONET or OTN frames) for communication over network 100, and vice versa. For example, a client 130 may transmit an Ethernet packet to a network element 110, which then may perform datagram segmentation, reassembly, and other tasks to convert the Ethernet packet into SONET frames. In another non-limiting example, the client 130 may transmit a SONET frame to the network element 110 and the network element 110 may perform tasks in order to be able to transmit the same datagram as an OTN frame.

Traffic may be originated at a desired client 130. Each client has a transmitter 103 to transmit traffic and a receiver 102 to receive traffic. In certain embodiments, this traffic is Ethernet traffic that is sent optically from and received optically by clients 130. Clients 130 may be coupled to network elements 110 via y-cables 140.

Y-cables 140 may be unidirectional. Each of y-cables 140 may include a two-to-one combiner-splitter. Accordingly, a y-cable 140 may include a splitter 144 configured to split traffic into two flows in one direction of traffic flow and a combiner 142 configured to combine two flows of traffic into a single path in the other direction of traffic flow. For example, when y-cable 140 is coupled to client 130, y-cable 140 may split traffic originating at client 130 into two flows and combines traffic to be received by client 130 into a single flow. This may provide redundancy in network 100 by providing multiple paths for traffic flow despite originating from or being passed to a single client 130. In some embodiments, network 100 may include y-cable 140a coupling near client 130a to near network element 110a, and may further include y-cable 140b coupling far client 130b to far network element 110b.

Near network element 110a may include multiple cards 112, for example, a first card 112a and a second card 112b. When referring to a card 112, it will be appreciated that a card 112 may be a physical component carrying or housing related components and/or features. Alternatively, a card 112 may be a logical grouping of related components and/or features without necessarily having physical proximity. A card 112 may include the components described below, but may further include other components including logic, memory, or combinations thereof. Card 112a may include two corresponding sets of receivers and transmitters, receiver 102b and transmitter 103b and receiver 102f and transmitter 103f. Receivers 102 and transmitters 103 may be optical receivers and transmitters. Card 112b may also include two corresponding sets of receivers and transmitters, receiver 102g and transmitter 103g and receiver 102j and transmitter 103j. By providing two cards, redundant equipment is provided in case of any defects, malfunctions, or errors with equipment by providing two potential paths traffic may flow along. This provides the basis for using y-cable 140, as two cards 112 are able to receive the two flows of traffic split by y-cable 140. Cards 112a and 112b need not have two sets of transmitters/receivers. For example, card 112a might have one receiver 102 and one transmitter 103 that are operable to convey information both from and to near client 130a and far network element 110b. Alternatively, card 112a might have multiple sets of transmitters/receivers, even beyond two. Additionally, in some embodiments, more than two cards 112 may be used.

Similarly, far network element 110b may include multiple cards, for example, a first card 112c and a second card 112d. Card 112c may include two corresponding sets of receivers and transmitters, receiver 102c and transmitter 103c and receiver 102e and transmitter 103e. Card 112d may also include two corresponding sets of receivers and transmitters, receiver 102h and transmitter 103h and receiver 102i and transmitter 103i. As described above with respect to cards 112a and 112b, cards 112c and 112d need not be limited to two sets of transmitters/receivers. Far client 130b may also include a receiver 102d and transmitter 103d.

FIG. 1 further depicts a variety of exemplary paths of signals among network 100, designated by the heavy arrows. While FIG. 1 depicts connections directly connecting near network element 110a and far network element 110b, it will be appreciated that any number of paths may be employed, including paths among different network elements, different networks, different medium, or any other feature of network 100 described above. Thus, the connections between network elements 110a and 110b are merely used for convenience in describing the disclosure, and are in no way limited to such direct connections.

For traffic to be communicated from near client 130a to far client 130b, near client 130a transmits a signal from transmitter 103a to splitter 144a within y-cable 140a. The signal may then be split into a first and second portion and both portions of the signal may be transmitted to cards 112a and 112b of near network element 110a. For example, the signal may be duplicatively split such that the first and second portions are identical. Card 112a receives the first portion of the split signal at receiver 102b and transmits the first portion of the split signal via transmitter 103b to far network element 110b. Card 112b receives the second portion of the split signal via receiver 102g and transmits the second portion via transmitter 103g to far network element 110b. In some embodiments, the cards 112 receive SONET frames and transmit OTN frames to far network element 110b. In other embodiments, the cards 112 receive OTN frames and transmit SONET frames to far network element 110b. In other embodiments, the cards 112 may receive and transmit the same frame type.

For example, cards 112 may receive and transmit SONET frames or may receive and transmit OTN frames. Furthermore, in some embodiments cards 112 may receive and transmit frames of any suitable transport type, depending upon the type of network to which they are communicatively coupled.

Receiver 102c of card 112c of far network element 110b receives the first portion of the signal transmitted from transmitter 103b. Receiver 102h of card 112d of far network element 110b receives the second portion of the signal transmitted from transmitter 103g. Far network element 110b selects one of card 112d or card 112c to transmit the received signal to receiver 102d of far client 130b. This may be transmitted via y-cable 140b through combiner 142b.

Signals flow in a similar manner from far client 130b to near client 130a through far network element 110b cards 112d and 112c. Far client 130b transmits a signal from transmitter 103d to splitter 144b within y-cable 140b. The signal may then be split into a first and second component and both components of the signal may be transmitted to cards 112c and 112d of far network element 110b. Card 112c receives a first portion of the split signal at receiver 102e and transmits the portion of the split signal via transmitter 103e to near network element 110a. Card 112d receives a second portion of the split signal via receiver 102i and transmits the portion via transmitter 103i to near network element 110a. Receiver 102f of card 112a of near network element 110a receives the first portion of the signal transmitted from transmitter 103e. Receiver 102j of card 112b of near network element 110a receives the second portion of the signal transmitted from transmitter 103i. Near network element 110a selects one of card 112b or card 112a to transmit the received signal to receiver 102a of near client 130a. This may be transmitted via y-cable 140a through combiner 142a.

In a y-cable protection scheme, y-cable 140 may allow for a redundant path of traffic between points within network 100. When a defect occurs in one traffic flow path, network 100 may employ one of the alternative traffic paths to protect and maintain the data flow between points within network 100. This may be accomplished by switching between cards 112 within a network element 110 as described below.

It will be appreciated that selecting and switching as described in the present disclosure may be performed by logic and/or memory associated with a network element 110 and/or client 130. Further switching may include physically powering or not powering a component; ignoring signals, traffic, or data from a component; gathering or listening to signals, traffic, or data from a component; or disabling or enabling certain aspects, features, or sub-components of a component.

In y-cable data protection switching schemes, cards 112 may be switched based on a defect in a particular direction of the traffic flow, providing more robust protection by having separate protection for each flow direction. In particular, traffic originating at client 130a is split at y-cable 140a and flows along both paths until it is to be passed to y-cable 140b at which point only one of cards 112c and 112d actually transmits the traffic to client 130b via y-cable 140b. Any defect along the redundant traffic flow path that passes through card 112c (the card 112 actually transmitting the traffic) may result in network element 110b switching which card 112 actually transmits the traffic from card 112c to card 112d, effectively switching to the alternative traffic flow path for this traffic flow direction. This only causes a switch for the traffic flow in one direction. This occurs separate and distinct from any switching done in the opposite flow direction. In like manner, for traffic that flows in the opposite direction, similar protection is provided. In some instances, a defect, for example a fiber breaking, may result in both network elements 110a and 110b switching cards 112, but they are switched independently. With regards to traffic flowing from near client 130a to far client 130b, if a defect were to occur in traffic flowing between near client 130a and splitter 144a, for example, if splitter 144a of y-cable 140a or transmitter 103a of near client 130a was defective, no action would be taken because network element 110b would be informed of failures through both incoming transmission lines. If a defect were to occur between splitter 144a and receiver 102b, for example, if receiver 102b was defective or transmission medium 160 between splitter 144a and receiver 102b were defective, far network element 110b would be informed that a defect occurred. Far network element 110b would select card 112d to transmit the signal, rather than card 112c, with no regard to where along the path the defect occurred. In like manner, if a defect were to occur between transmitter 103b and receiver 102c, for example if transmitter 103b or receiver 102c were defective, far network element 110b would be informed that a defect occurred. Far network element 110b would select card 112d to transmit the signal, rather than card 112c. Similarly, if a defect were to occur between transmitter 103c and combiner 142b, for example, if transmitter 103c was defective, far client 130b would inform far network element 110b that it did not receive the signal. Far network element 110b would select card 112d to transmit the signal, rather than card 112c. This may provide protection for signals transmitted from near client 130a to far client 130b by switching at far network element 110b. In revertive systems, once a defect has been cleared, a network element may switch back to an initially selected card for transmitting a signal. For example, if card 112c was initially transmitting the signal and card 112d was selected due to a defect, when the defect is cleared, card 112c would again be selected to transmit the signal. In a non-revertive system, rather than reverting to card 112c to transmit the signal upon clearing a defect, card 112d would continue to transmit the signal.

In some embodiments of the present disclosure, a network element 110a may be configured to provide unidirectional switching, i.e. switching that can be done for only one direction of traffic flow, at the near end based on defects associated with receiving a management component of a signal originating from near client 130a in order to maintain the connection between client 130a and network element 110a.

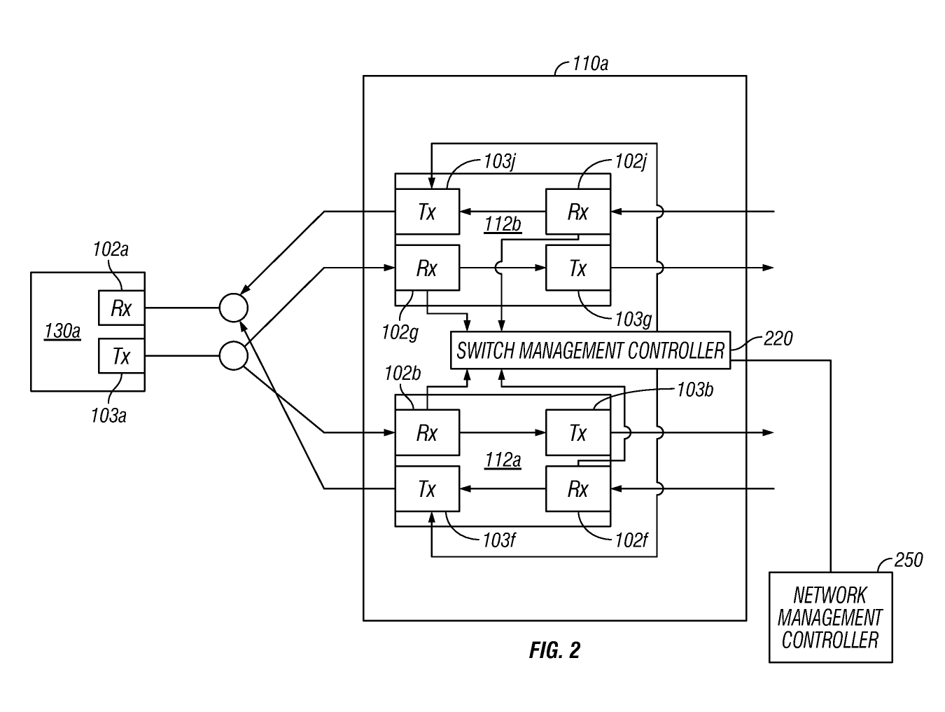

FIG. 2 illustrates an embodiment of the present disclosure showing communication paths between client 130a and network element 110a.

Network element 110a may include a switch management controller 220 communicatively coupled to switch cards 112. Specifically, switch management controller 220 may be communicatively coupled to and configured to receive inputs from receivers 102b, 102f, 102g, and 102j. Based upon various operational logic as described below, switch management controller 220 may be communicatively coupled to and configured to control operations of transmitters 103f, 103j. Specifically, switch management controller 220 may be configured to set one of transmitters 103f, 103j as active such that its output will be routed towards client 130a. In one embodiment, transmitters 103g, 103b may constantly transmit the inputs received from receivers 102g, 102b, respectively.

It will be appreciated that switch management controller 220 may include or be implemented by any component configured to select and/or switch between locations designated to receive a signal. Switch management controller 220 may further include logic and/or memory to facilitate the selection. Switch management controller 220 may be implemented by, for example, a processor, a microcontroller, an Application Specific Integrated Circuit, a Field-Programmable Gate Array, or module, application, script, function, code, or instructions resident in a memory for execution by such hardware.

Switch management controller 220 may be communicatively coupled to a network management controller 250. Network management controller 250 may be configured to issue user-generated signals or commands to switch management controller 220. Such commands may include, for example a forced switch or a manual switch command. Network management controller 250 may be resident in any suitable server, device, or other entity for providing user control to elements of network 100 such as network management controller 250. Network management controller 250 may provide a user interface for one or more users to provide management commands, controls, or other inputs into network 100. Upon entering of various management commands, controls, or other inputs, network management controller 250 may be configured to translate such input, if necessary, and issue resultant communication to switch management controller 220. Network management controller 250 may be implemented by, for example, a processor, a microcontroller, an Application Specific Integrated Circuit, a Field-Programmable Gate Array, or module, application, script, function, code, or instructions resident in a memory for execution by such hardware.

The same protection at near network element 110a may also be present for signals transmitted from far client 130b via far network element 110b.

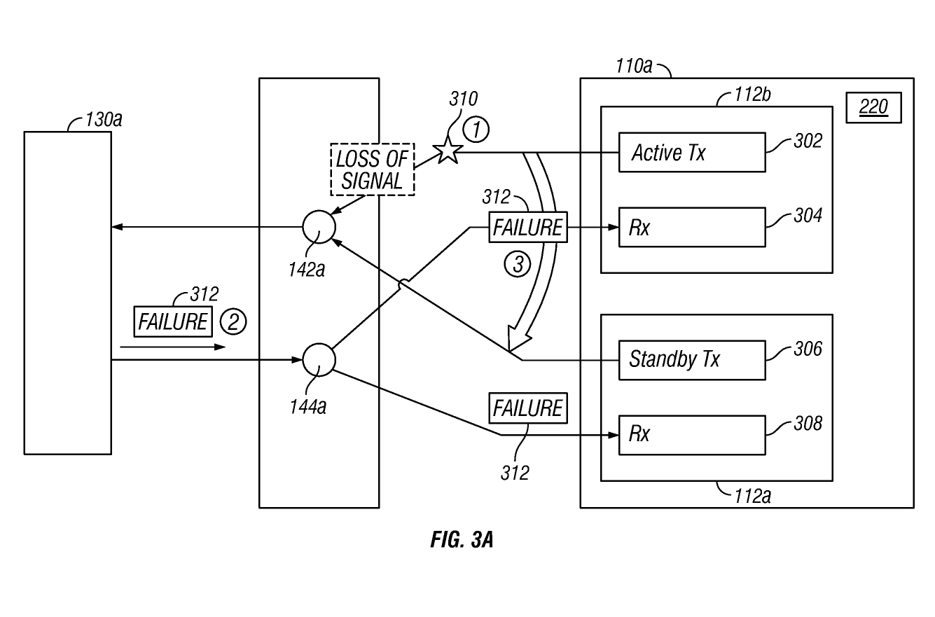

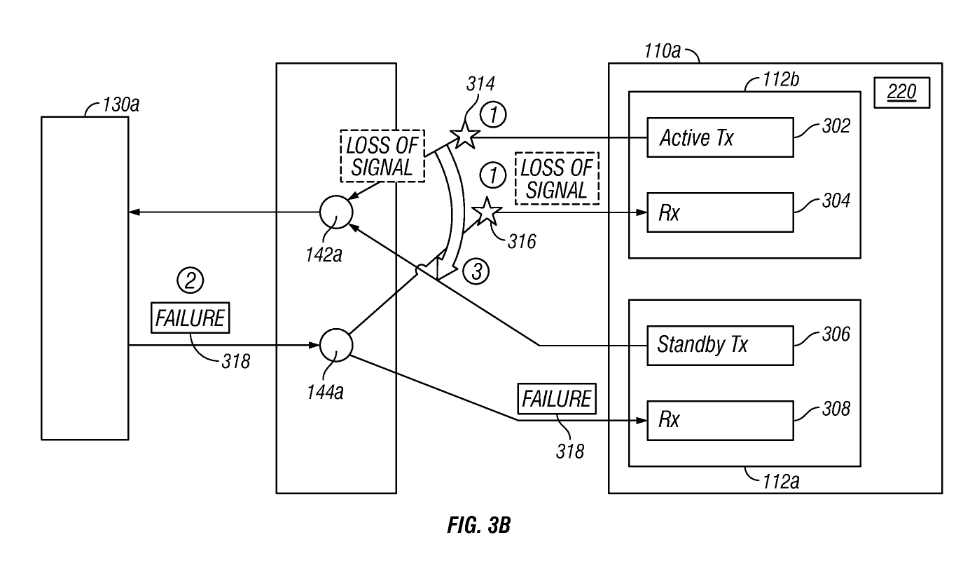

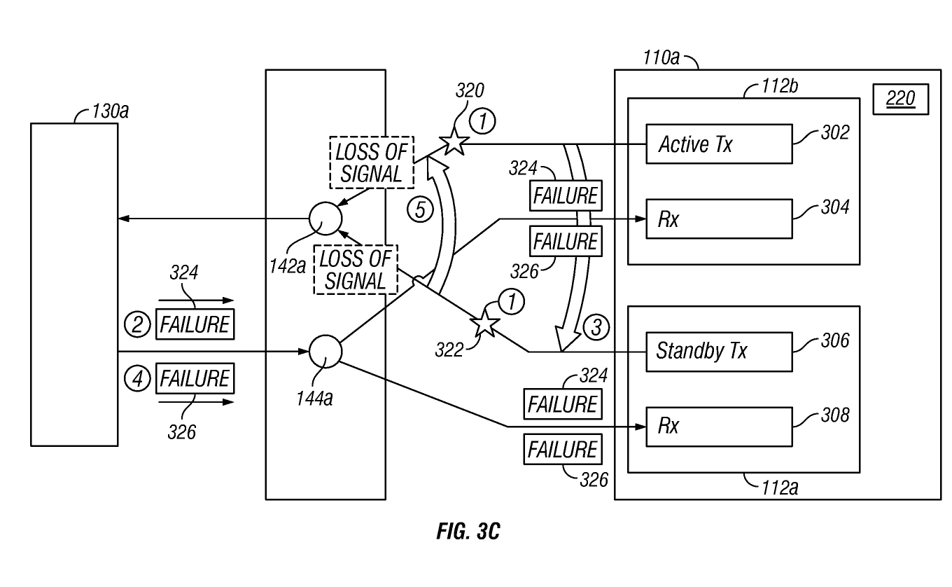

FIGS. 3A, 3B, and 3C illustrate operation of network 100 to detect backward defect indications in y-cabling components. Backward defects may include, for example, errors resulting after traffic has been sent to clients 130. The errors may include errors occurring on a client's transmission media, such as fiber.

The implementation, nomenclature, and other aspects of a notification regarding a backward defect may depend upon the implementation of network 100. For example, given use of Optical Carrier Level N (Ocn), a notification of a backward defect may include a Remote Defect Indication (RDI); given use of Optical Transport Units (OTU), a notification of a backward defect may include a Backward Defect Indicator (BDI); given use of gigabit Ethernet (GbE), a notification of a backward defect may include a Remote Fault (RF).

Errors occurring within the domain of clients 130 may not be detectable in near-end equipment such as near network element 110a, unless the near-end equipment receives a client-specific backward defect indication from client 130a. Furthermore, the client's own receiver fiber may be inoperable, such that a backward defect indicator may be received by network element 110a. Portions of network 100, such as network element 110a, may be configured to perform y-cable switching in response to failures in the transmission of data to clients such as client 130a. In addition, errors may occur during the process of receiving responses from a client in locations such as splitters 142a, 144a, of y-cabling. Portions of network 100 may be configured to perform y-cable switching in response to such errors. Furthermore, network 100 may be configured to perform periodic polling to recover from errors occurring simultaneously in transmission media to and from client 130a.

In one embodiment, such switching and handling may be performed entirely within a near-end network element, such as near network element 110a. Thus, the handling may be local to elements of network 100 nearest to client 130a. Furthermore, such handling may be made with regards to unidirectional protection switching.

In the example of FIGS. 3A, 3B, and 3C, active Tx 302 may implement fully or in part card 112b including transmitter 103j; Rx 304 may implement fully or in part card 112b including receiver 102g; standby Tx 306 may implement fully or in part card 112a including transmitter 103f; and Rx 308 may implement fully or in part card 112a including receiver 102b. The designation of some such elements as “active” and “standby” may be made in relation to an instant status of protection switching as operating on network 100. In various embodiments, the designation of such elements as “active” and “standby” may be reversed as applicable. Control of designation of “active”, “standby” and switching may be made by configurations of switch management controller 220. A protection domain may exist for the far end via a receiving path from client 130a going through near network element 110a. A protection domain may exist for a receiving path for the near end via a receiving path going through near network element 110a going to client 130a.

In FIG. 3A, an interruption 310 may occur within the transmission media between active Tx 302 and client 130a. Such an interruption may occur between active Tx 302 and combiner 142a, or between combiner 142a and client 130a. The timing of interruption action may be denoted by (1). Consequently, a loss-of-signal may be experienced downstream from interruption 310.

In response to the loss-of-signal, client 130a may generate a failure signal 312. Failure signal 312 may include a backward defect indicator or remote fault that client 130a failed to receive expected traffic. The timing of generation of failure signal 312 may be denoted by (2). Failure signal 312 may be sent between client 130a and splitter 144a. Furthermore, failure signal 312 may be sent between splitter 144a and Rx 304 and between splitter 144a and Rx 308. Thus, failure signal 312 may be received by both Rx 304 and Rx 308.

Upon receipt of failure signal 312 by both Rx 304 and Rx 308, near network element 110a may determine that an error has occurred in the transmission media used to transmit information to client 130a. Specifically, such an error may have occurred between active Tx 302 and client 130a. As a result of the determination, switch management controller 220 may be configured to switch transmission to combiner 142a from active Tx 302 to standby Tx 304. The timing of switching may be denoted by (3).

In FIG. 3B, an interruption 314 may occur within the transmission media between active Tx 302 and client 130a. Such an interruption may occur between active Tx 302 and combiner 142a, or between combiner 142a and client 130a. Furthermore, an interruption 316 may occur within the transmission media between client 130a and Rx 304. Such an interruption may occur between client 130a and splitter 144a, or between splitter 144a and Rx 304. The timing of such interruption action may be denoted by (1). Consequently, a loss-of-signal may be experienced downstream from interruption 314. In addition, a loss-of-signal may be experienced upstream from interruption 316.

In response to the loss-of-signal from near network element 110a, client 130a may generate a failure signal 318. Failure signal 318 may include a backward defect indicator that client 130a failed to receive expected traffic. The timing of generation of failure signal 318 may be denoted by (2). Failure signal 318 may be sent between client 130a and splitter 144a. Furthermore, failure signal 318 may be sent between splitter 144a and Rx 308. However, failure signal 318 may not be received at Rx 304 because of interruption 316.

Upon receipt of failure signal 318 by Rx 308 but not by Rx 304, near network element 110a may determine that an error has occurred in the transmission media used to transmit information to client 130a and in the transmission media used to receive information from client 130a. Specifically, network element 110a may determine that an error has occurred between active Tx 302 and client 130a, and that an error has occurred between client 130a and Rx 304. As a result of the determination, switch management controller 220 may be configured to switch transmission to combiner 142a from active Tx 302 to standby Tx 304. The timing of switching may be denoted by (3).

Thus, generally, if a failure signal, which may include a backward defect indicator, is received on (a) an active or working path facility such as a receiver; (b) a standby or protect path facility such as a receiver; or (a) and (b), the transmission through the associated y-cable may be switched to the standby or protect transmission facility.

Although Rx 304 is described as “active” and Rx 308 is described as “standby”, within the context of FIG. 3B such designations as specifically “active” or “standby” may not particularly apply to the operation of Rx 304 and Rx 308 in the same manner as such designations apply to, for example, active Tx 302 and standby Tx 306. Both Rx 304 and Rx 308 may be monitored for input. Within the context of FIG. 3B, the denotation of Rx 304 as “active” may serve to illustrate an association with active Tx 302 and the denotation of Rx 308 as “standby” may serve to illustrate an association with standby Tx 306.

In FIG. 3C, an interruption 320 may occur within the transmission media between active Tx 302 and client 130a. Such an interruption may occur between active Tx 302 and combiner 142a, or between combiner 142a and client 130a. Furthermore, an interruption 322 may occur within the transmission media between standby Tx 306 and client 130a. Such an interruption may occur between standby Tx 306 and combiner 142a, or between combiner 142a and client 130a. The timing of such interruption action may be denoted by (1). Consequently, a loss-of-signal may be experienced downstream from interruptions 320 and 324.

In response to the loss-of-signal from near network element 110a, client 130a may generate a failure signal 324. Failure signal 324 may include a backward defect indicator that client 130a failed to receive expected traffic. The timing of generation of failure signal 318 may be denoted by (2). Failure signal 324 may be sent between client 130a and splitter 144a. Furthermore, failure signal 324 may be sent between splitter 144a and Rx 308 and between splitter 144a and Rx 304.

Upon receipt of failure signal 324 by Rx 308 and Rx 304, near network element 110a may determine that an error has occurred in the transmission media used to transmit information to client. As a result of the determination, switch management controller 220 may be configured to switch transmission to combiner 142a from active Tx 302 to standby Tx 304. The timing of switching may be denoted by (3).

However, because of interruption 322, subsequently client 130a may still not receive traffic from near network element 110a. While interruption 322 was described above as occurring in conjunction with (1), interruption 322 may have occurred at any point before client 130a detects, for a second time, that no traffic has been received from near network element 110a.

In response to the continued loss-of-signal from active Tx 302, client 130a may generate a failure signal 326. Failure signal 326 may include a backward defect indicator that client 130a failed to receive expected traffic. The timing of generation of failure signal 318 may be denoted by (4). Failure signal 326 may be sent between client 130a and splitter 144a. Furthermore, failure signal 326 may be sent between splitter 144a and Rx 308 and between splitter 144a and Rx 304.

Upon receipt of failure signal 326 by Rx 308 and Rx 304, near network element 110a may determine that an error has occurred in the transmission media used to transmit information to client. As a result of the determination, switch management controller 220 may be configured to switch transmission to combiner 142a from standby Tx 304 to active Tx 302. The timing of switching may be denoted by (5).

The cycling of switching transmission between standby Tx 304 and active Tx 302 may continue until one of interruptions 320, 322 is cleared. Near network element 110a may determine that, based upon the detection of failure signals 326, both transmission media from active Tx 302 and standby Tx 304 are interrupted. Based on such a determination, near network element 110a may continue to switch y-cabling paths periodically until a failure signal is not received.

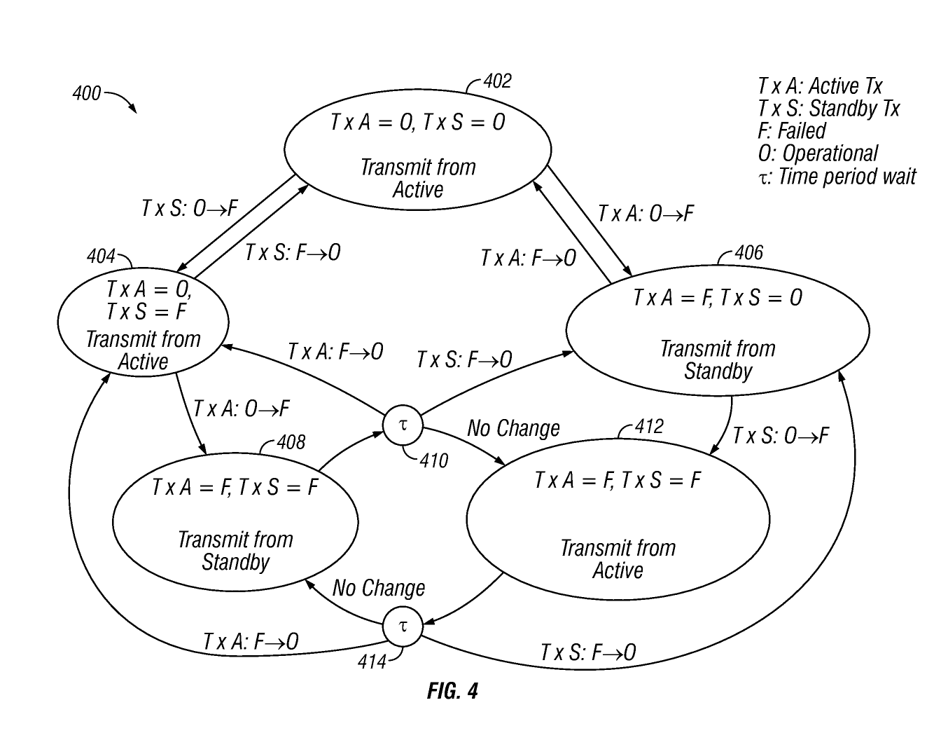

FIG. 4 is an example embodiment of a state graph 400 illustrating operation of near network element 110a when experiencing failures in both standby and active transmission paths. At 402, operation may be normal. Transmission from active Tx 302 and standby Tx 306 may be determined to be operating normally. Transmission may be made through active Tx 302 to client 130a. Upon a subsequent determination through, for example, a backward defect indicator or other indication that the transmission path from active Tx 302 to client 130a has failed, the state of operation may move to 406. In 402 and upon a subsequent determination through, for example, a backward defect indicator or other indication that the transmission path from standby Tx 306 to client 130a has failed, the state of operation may move to 404.

At 404, transmission to client 130a may be attempted through active Tx 302. If necessary, a switch of transmission from standby Tx 306 to active Tx 302 may be made. Transmission from active Tx 302 may have been determined or presumed to be operating normally but transmission from standby Tx 306 may have been determined to have failed. Upon a subsequent determination through, for example, a backward defect indicator or other indication that the transmission path from active Tx 302 to client 130a has failed, the state of operation may move to 408. In 404 and upon a subsequent determination through, for example, a lack of a backward defect indicator or other indication that the transmission path from standby Tx 306 to client 130a has recovered, the state of operation may move to 402.

At 406, transmission to client 130a may be attempted through standby Tx 306. If necessary, a switch of transmission from active Tx 302 to standby Tx 306 may be made. Transmission from active Tx 302 may have been determined to have failed but transmission from standby Tx 306 may have been determined or presumed to have been operating normally. Upon a subsequent determination through, for example, a backward defect indicator or other indication that the transmission path from standby Tx 306 to client 130a has failed, the state of operation may move to 412. In 406 and upon a subsequent determination through, for example, a lack of a backward defect indicator or other indication that the transmission path from active Tx 302 to client 130a has recovered, the state of operation may move to 402.

At 408 and 412, transmission from active Tx 302 and standby Tx 306 may have been determined to have failed.

At 408, if necessary, a switch of transmission from active Tx 302 to standby Tx 306 may be made. Operation may move to 410.

At 412, if necessary, a switch of transmission from standby Tx 306 to active Tx 302 may be made. Operation may move to 414.

At 410, operation with regards to switching may be paused for a time period τ, yielding a polling interval. Any suitable value of τ may be used, such as five minutes. Upon expiration of τ, it may be determined whether any changes have occurred with regards to the paths between active Tx 302 or standby Tx 306 and client 130a. If no changes have been made, operation may move to 412. If a lack of backward defect indicator or other indication that the transmission path from standby Tx 306 to client 130a has recovered, the state of operation may move to 406. In 410 and upon a subsequent determination through, for example, a lack of a backward defect indicator or other indication that the transmission path from active Tx 302 to client 130a has recovered, the state of operation may move to 404.

At 414, operation with regards to switching may be paused for a time period τ, yielding a polling interval. Upon expiration of τ, it may be determined whether any changes have occurred with regards to the paths between active Tx 302 or standby Tx 306 and client 130a. If no changes have been made, operation may move to 408. If a lack of backward defect indicator or other indication that the transmission path from standby Tx 306 to client 130a has recovered, the state of operation may move to 406. In 414 and upon a subsequent determination through, for example, a lack of a backward defect indicator or other indication that the transmission path from active Tx 302 to client 130a has recovered, the state of operation may move to 404.

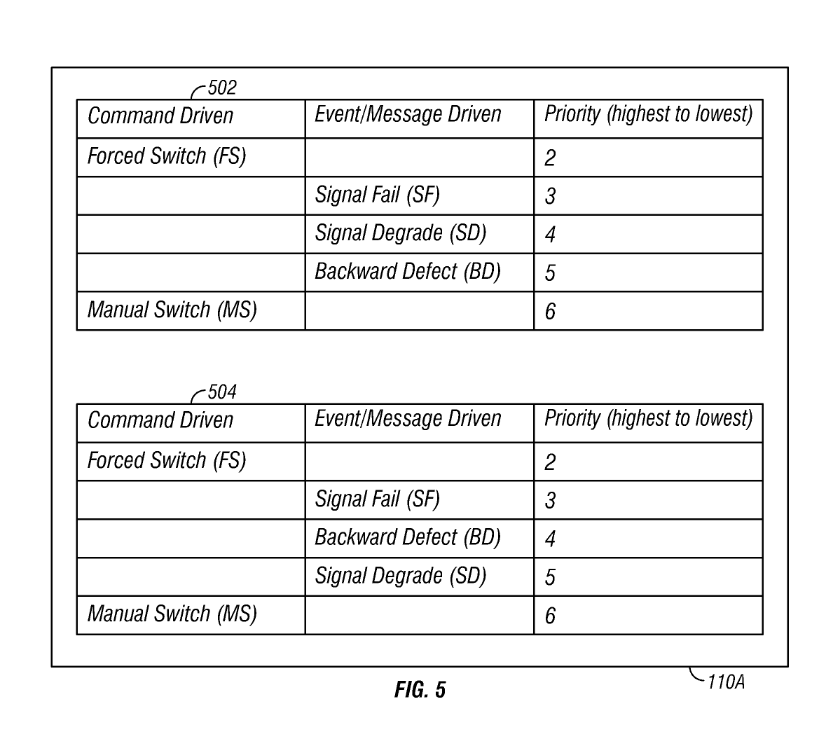

FIG. 5 illustrates an example embodiment of priority tables 502, 504 for handling backward defect indicators. Priority tables 502, 504 may be utilized by any suitable portion of network 100 to determine how to handle backward defect indicators in relation to other protection switching messages, when such backward defect indicators are received in the context of y-cable switching. For example, near network element 110a may include a copy of one of priority tables 502, 504 and determine how to perform switching if a backward defect indicator is received within the context of other protection switching messages.

Existing priorities defined by, for example, the International Telecommunication Union G.873.1 standard may be insufficient. Such existing priority schemes may include, for example, prioritization among Forced Switch (FS), Signal Fail (SF), Signal Degrade (SD), and Manual Switch (MS) events and commands. Merely assigning a backward defect indicator to, for example, a SF, SD, or other status may be insufficient because backward defect indicators may be received on both paths—Rx 304 and Rx 308—when using y-cable switching. Switching priorities may thus be same on both paths. Y-cable switching on backward defect indicators, as shown above in conjunction with FIGS. 3A, 3B, and 3C, may allow for a fault-free path to be selected. Such advantages may be lost without prioritization of backward fault indicators in view of other protection switching messages. SF and SD messages may be received by, for example, receiver 102j or receiver 102f as shown in FIG. 1. Receiver 102j may be communicatively coupled to transmitter 103j, which may be implemented by active Tx 302. Thus, card 112b may receive SF and SD messages from the network. Receiver 102f may be communicatively coupled to transmitter 103f, which may be implemented by standby Tx 306. Thus, card 112a may receive SF and SD messages from the network.

Portions of network 100, such as near network element 110a, may simultaneously, or nearly simultaneously, receive protection switching from other portions of network 100 and backward defect indicators from, for example, client 130a. Furthermore, near network element 110a may receive commands from network management controller 250. Network 100 may be configured to use prioritization as illustrated in priority tables 502, 504 to resolve such switching contentions. In one embodiment, protection switching defects received from portions of network 100 other than client 130a may be given higher priority than backward defect indicators received from client 130a. Network 100 may thus facilitate y-cable switching. A priority level describing backward defect indicators received from client 130a may be labeled “BD.” In another embodiment, a BD priority may have lower priority than an SF level and a lower priority than an SD level. In yet another embodiment, a BD priority may have lower priority than an SF level but a higher priority than an SD level. In still yet another embodiment, y-cable switching may be facilitated by network 100 even if both paths receive the same BD priority level.

One of priority tables 502, 504 may be used by each portion of network 100. Priority tables 502, 504 may be implemented in any suitable manner, such as by a table, record, string, file, data structure, list, database, function, script, code, or any other suitable entity to store, retrieve, or yield priorities for switching to be applied to network 100 as described below. Priority tables 502, 504 may be resident within any suitable portion of network 100, and may be communicatively coupled to any suitable portion therein.

In one embodiment, network 100 may utilize a priority table such as priority table 502. Priority table 502 may specify that a BD priority may have lower priority than an SF level and a lower priority than an SD level. Thus, priority table 502 may comprise an entry for a command for FS with a highest priority, such as two. Priority table 502 may comprise an entry for an event or message for SF with a lower priority, such as three. Furthermore, priority table 502 may comprise an entry for an event or message for SD with an even lower priority, such as four. Priority table 502 may comprise an entry for an event or message for a BD with an even yet lower priority, such as five. Furthermore, priority table 502 may comprise an entry for a command for a MS with a further lower priority, such as six.

In another embodiment, network 100 may utilize a priority table such as priority table 504. Priority table 504 may specify that a BD priority may have lower priority than an SF level but a higher priority than an SD level. Thus, priority table 502 may comprise an entry for a command for FS with a highest priority, such as two. Priority table 502 may comprise an entry for an event or message for SF with a lower priority, such as three. Furthermore, priority table 502 may comprise an entry for an event or message for BD with an even lower priority, such as four. Priority table 502 may comprise an entry for an event or message for an SD with an even yet lower priority, such as five. Furthermore, priority table 502 may comprise an entry for a command for a MS with a further lower priority, such as six.

Given the receipt of a network message such as a protection switching message and a backward defect indicator, elements of network 100, such as near network element 110a, may consult one of priority tables 502, 504 to determine how to perform y-cable switching. Performing y-cable switching may include determining which of, for example, active Tx 302 or standby Tx 306 is to be routed to client 130a. After consulting the priority illustrated in the selected one of priority tables 502, 504, near network element 110a may make switching changes or maintain switching using, for example, switch management controller 220.

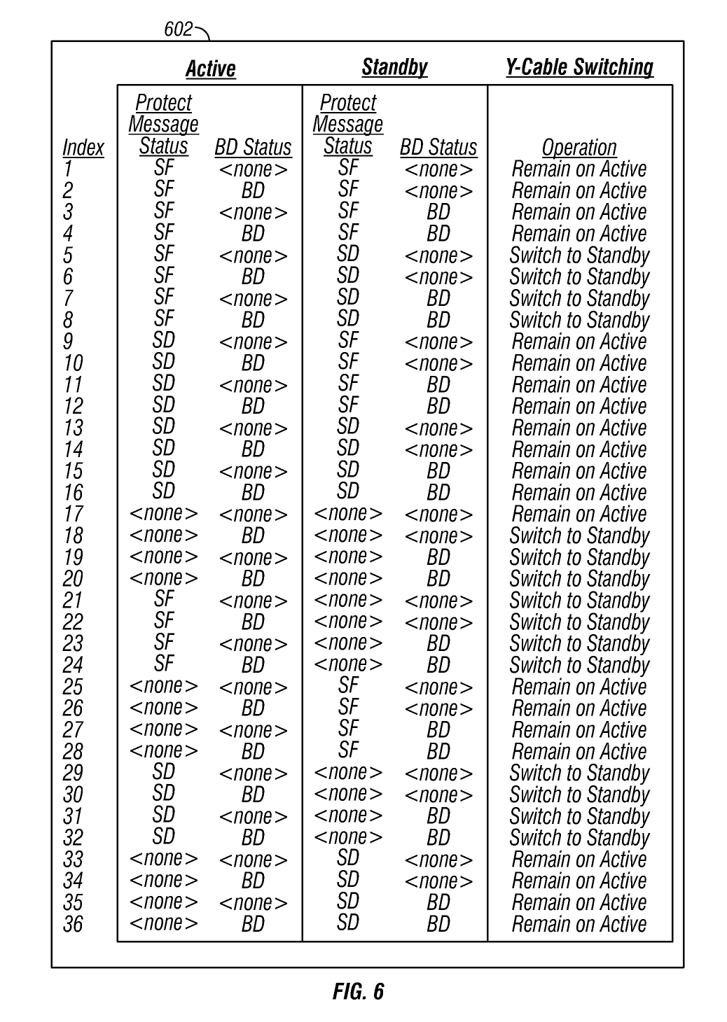

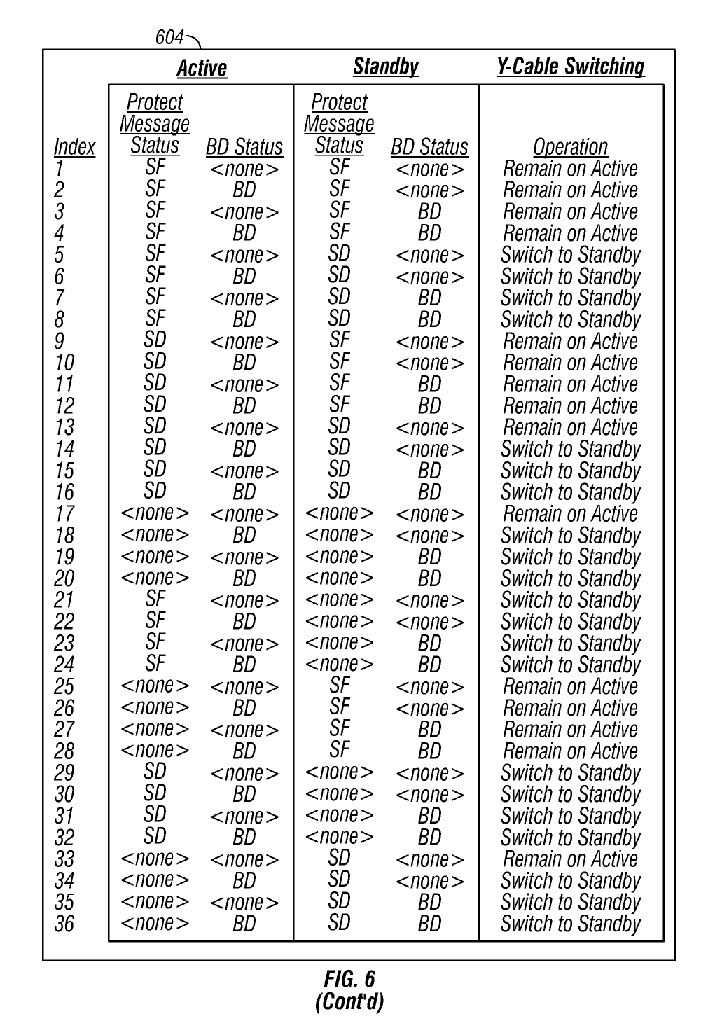

FIG. 6 illustrates an example embodiment of use cases 602, 604 for receipt of various messages on an active facility and a standby facility. Such facilities may include, for example, cards 112a, 112b. Uses cases 602, 604 may specify switching status of y-cabling to be applied in various such circumstances. Use cases 602, 604 may illustrate, for example, operation of switch management controller 220 to determine which of active Tx 302 and standby Tx 306 will be routed to client 130a. Use cases 602, 604 may be determined by application of priority tables 502, 504 respectively in view of traditional behavior in conjunction with received SF, SD behavior.

The operation of switch management controller 220 with use cases 602, 604 may be based on, for example, messages received on Rx 304 (including any portion of card 112b) and Rx 308 (including any portion of card 112a). Messages received on Rx 304 may include protection switching messages received through receiver 102j or receiver 102g. Furthermore, messages received on Rx 304 may include backward defect indicators received from client 130a on receiver 102g. Messages received on Rx 308 may include protection switching messages received through receiver 102f or receiver 102b. Furthermore, messages received on Rx 304 may include backward defect indicators received from client 130a on receiver 102b.

The operation of switch management controller 220 to switch between active and standby may include switching the routing between, for example, active Tx 302 and standby Tx 306 to combiner 142a. Furthermore, as the designations of active or standby change for a given component, so would the application of use cases 602, 604 to network 100.

In one embodiment, use cases 602, 604 may represent the operation and effect of application of priority tables 502, 504, respectively. In another embodiment, use cases 602, 604 may implement decision logic to be applied by various portions of network 500. In such an embodiment, use cases 602, 604 may be implemented in any suitable manner, such as by a table, record, string, file, data structure, list, database, function, script, code, or any other suitable entity to store, retrieve, or yield a determined y-cable switching action. Furthermore, in such an embodiment, use cases 602, 604 may be resident within any suitable portion of network 100, and may be communicatively coupled to any suitable portion therein. Use cases 602, 604 may be configured in accordance with priority tables 502, 504, respectively, as shown above.

In one embodiment, network 100 may utilize a priority table such as priority table 502 resulting in the operation shown in use case 602. The specifics of switching operations may be specified given a status of an active facility and a status of a standby facility. The status of each facility may include a protection message status—such as a received SF message, received SD message, or no such received message—and a received BD status, such as a BD received or not.

In another embodiment, network 100 may utilize a priority table such as priority table 504 resulting in the operation shown in use case 604. The specifics of switching operations may be specified given a status of an active facility and a status of a standby facility. The status of each facility may include a protection message status—such as a received SF message, received SD message, or no such received message—and a received BD status, such as a BD received or not.

Given the receipt of a network message such as a protection switching message and a backward defect indicator, elements of network 100, such as near network element 110a, may consult one of priority tables 502, 504 to determine how to perform y-cable switching. Performing y-cable switching may include determining which of, for example, active Tx 302 or standby Tx 306 is to be routed to client 130a. Incoming messages may be monitored on active facilities, such as card 112b, and on standby facilities, such as card 112a. After consulting the priority illustrated in the selected one of priority tables 502, 504 in view of standard protection switching operations, near network element 110a may make switching changes or maintain switching using, for example, switch management controller 220. Such changes may be performed according to the operations shown in use cases 502, 504, respectively, according to the selection of priority tables 502, 504. Switching to standby facilities may include redesignation of active and standby facilities.

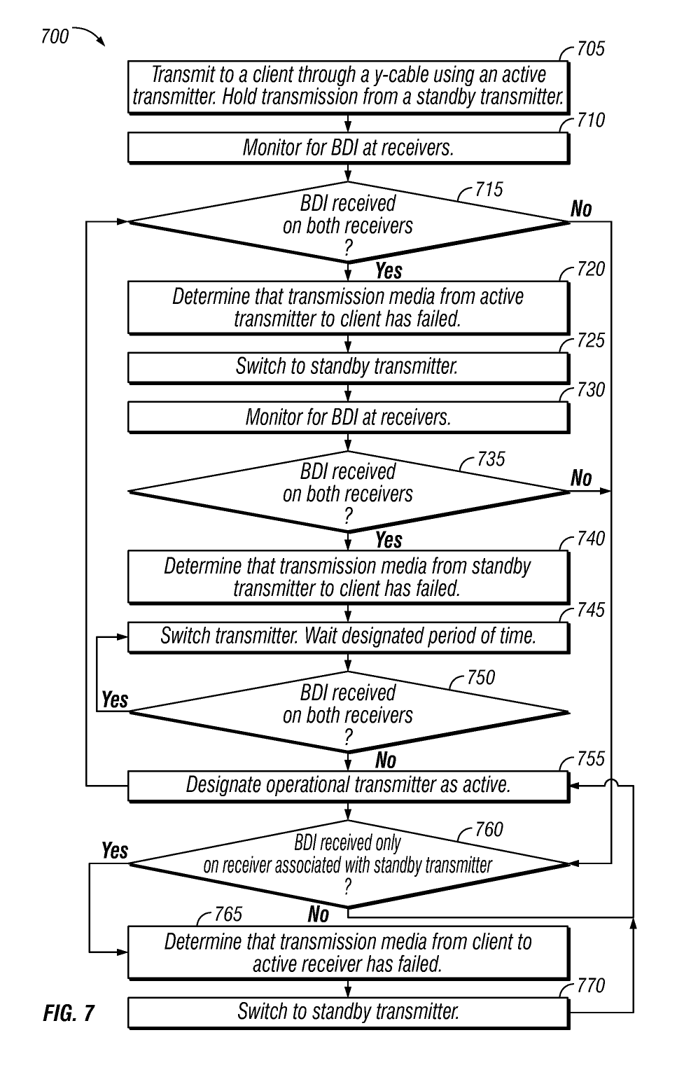

FIG. 7 is an illustration of an example embodiment of a method 700 for performing backward defect detection in y-cabling. At 705, information may be transmitted to a client by a network element through a y-cable with branches coupled to the network element and the stem coupled to the client. The transmission may be conducted using a transmitter of an element designated as an active facility. Transmission may be available from a corresponding standby facility, but such transmission may be presently held and not sent to the client.

At 710, monitoring for backward defect indicators (BDI) may be conducted. Such monitoring may be performed at receivers of the active and standby facilities. At 715, if any BDI has been received, it may be determined whether such a BDI was received on both receivers. If not, method 700 may proceed to 760. If so, at 720 it may be determined that transmission media from the active transmitter to the client has failed. At 725, transmission may be switched to the standby transmitter, such that traffic is attempted to be delivered to the client from the standby transmitter.

At 730, monitoring for BDI may be conducted at both receivers. At 735, it may be determined whether such a BDI was received on both receivers. If not, method 760 may proceed to 760. If so, at 740 it may be determined that transmission media from the standby transmitter has failed. At 745, the choice of transmitter may be switched. If the active transmitter was in use, then the standby transmitter may be employed. If the standby transmitter was in use, then the active transmitter may be employed. Waiting may be performed until expiration of a designated period of time, such as five minutes. At 750, it may be determined whether BDI was received on both receivers. If so, method 700 may return to 745. If not, in 755, the operational transmitter may be designated as the active transmitter. Transmission to the client may be performed by the designated active transmitter. Method 700 may return to 710.

At 760, it may be determined whether BDI was received on one receiver but not the other. If not, method 700 may proceed to 755. If so, at 765 it may be determined that transmission media from the client to the receiver has failed. At 770, the choice of transmitter may be switched. For example, transmission may be switched to the standby transmitter, such that traffic is attempted to be delivered to the client from the standby transmitter. Method 700 may return to 755.

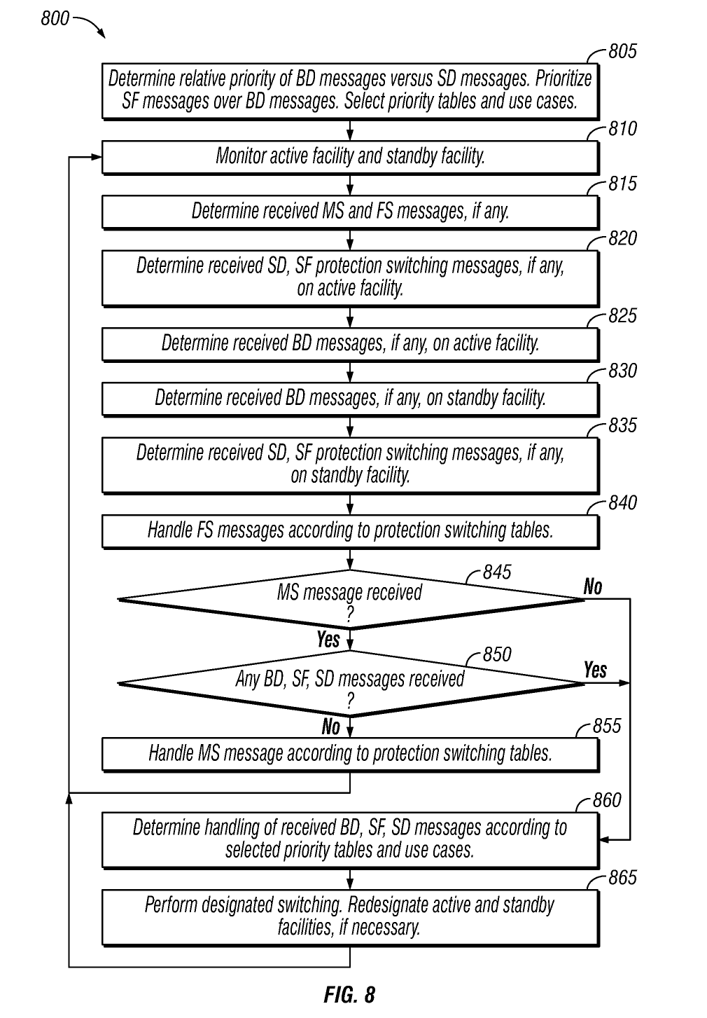

FIG. 8 is an illustration of an example embodiment of a method 800 for handling prioritization of backward defect messages in combination with other protection switching messages.

At 805, relative priority may be determined between BD messages and protection switching messages. In one embodiment, the relative priority between BD messages and SD messages may be determined. For example, BD messages may be prioritized over SD messages, or SD messages may be prioritized over BD messages. In another embodiment, both BD messages and SD messages may be prioritized over MS messages. In yet another embodiment, both BD messages and SD messages may be prioritized below SF messages and FS messages. In still yet another embodiment, FS messages may be prioritized over SF messages. To make priority determinations, priority tables may be selected or accessed. Furthermore, use cases resulting from the choice of priority tables may be determined or yielded from application of the priority tables. In various embodiments, the priority tables may thus prioritize SF messages over BD messages, and the prioritization of BD messages versus SD messages may be made according to preferred results as illustrated in FIG. 6.

At 810, active facilities and standby facilities at a portion of a network may be monitored. Such a portion of a network may include an element transmitting information to a client through a y-cable with branches coupled to the network element and the stem coupled to the client. The transmission may be conducted using a transmitter of an element designated as the active facility. Transmission may be available from the corresponding standby facility, but such transmission may be presently held and not sent to the client.

At 815, any received MS and FS messages may be determined. At 820, any received SD or SF messages received at the active facility may be determined. At 825, any BD messages received at the active facility may be determined. At 830, any received SD or SF messages received at the standby facility may be determined. At 835, any BD messages received at the standby facility may be determined. Such received message determinations may be used to determine how to perform y-cable switching.

At 840, if any FS messages have been received, they may be handled according to protection switching tables. Such tables may include any suitable table. Such tables may include a table that does not reference handling of BD messages or otherwise ignores the impact of BD messages upon FS message handling.

At 845, it may be determined whether any MS messages were received. If not, method 800 may proceed to 860. If so, at 850 it maybe determined whether any BD, SF, or SD messages were received. If so, method 800 may proceed to 860. If not, at 855 the MS messages may be handled according to protection switching tables. Such tables may include any suitable table. Such tables may include a table that does not reference handling of BD messages or otherwise ignores the impact of BD messages upon MS message handling. Method 800 may return to 810.

At 860, the determination of the received BD, SD, and SF messages by the active facility and the standby facility may be used to access the selected priority tables and use cases. By looking up or referencing the particular combination of received BD, SD, and SF messages in the active facility and the standby facility, a determination of y-cable switching may be made. At 865, y-cable switching may be performed. Such switching may include maintaining transmission on the active facility or switching transmission to the standby facility. If necessary, the designation of which facility is active and which facility is standby may be switched. Method 800 may return to 810.

Methods 700 and 800 may be performed at a near-end of a network utilizing y-cabling to interface with a client, or in any other suitable portion of the network. Such a network may include network 100. Methods 700 and 800 may be performed by any suitable network component or part of the network 100 disclosed in FIGS. 1-6, such as near-end network element 110a. Although FIGS. 7-8 disclose a particular number of steps to be taken with respect to example methods 700 and 800, methods 700 and 800 may be executed with more or fewer steps than those depicted in FIGS. 7-8. In addition, although FIGS. 7-8 disclose a certain order of steps to be taken with respect to methods 700 and 800, the steps comprising these methods may be completed in any suitable order. In certain embodiments, methods 700 and 800 may be implemented partially or fully in logic or in software. Logic may include hardware, software, and/or other logic. Logic and software may be encoded in one or more tangible computer readable storage media and may perform operations when executed by a computer. Certain logic, such as a processor, may manage the operation of a component. Examples of a processor include one or more computers, one or more microprocessors, one or more applications, and/or other logic.

A memory may store information. A memory may comprise one or more tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

Modifications, additions, or omissions may be made to network 100 without departing from the scope of the disclosure. The components of network 100 may be integrated or separated. Moreover, the operations of network 100 may be performed by more, fewer, or other components. Additionally, operations of network 100 may be performed using any suitable logic.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions has been described in detail, it should be understood that the various changes, substitutions, and alterations could be made hereto without departing from the spirit and scope of the invention.

What is claimed is:

1. A method comprising:
at a network element communicatively coupled to a y-cable through a first transmitter of the network element designated as an active transmitter and a second transmitter of the network element designated as a standby transmitter, transmitting data from the first transmitter through the y-cable to a client and withholding transmission from the second transmitter;
determining whether a first receiver has received a first backward defect indicator from the client;
determining whether a second receiver has received the first backward defect indicator from the client;
based on the determination regarding whether a first receiver has received the first backward defect indicator from the client and the determination whether a second receiver has received the first backward defect indicator from the client, determining that an interruption has occurred within a transmission media between the network element and the client; and
based on the determination of the interruption, transmitting data from the second transmitter through the y-cable to the client and withholding transmission from the first transmitter.

2. The method of claim 1, further comprising:
determining that the first receiver has received the first backward defect indicator;
determining that the second receiver has received the first backward defect indicator; and
based on the determinations that the first receiver and the second receiver have received the first backward defect indicator, determining that an interruption has occurred in conjunction with a transmission media between the first transmitter and the client.

3. The method of claim 1, further comprising:
determining that the first receiver has not received a backward defect indicator;
determining that the second receiver has received the first backward defect indicator; and
based on the determination that the first receiver has not received the backward defect indicator and the determination that the second receiver has received the first backward defect indicator, determining that an interruption has occurred between the first transmitter and the client and between the client and the first receiver.

4. The method of claim 1, further comprising, subsequent to transmitting data from the second transmitter through the y-cable to the client:
determining that the first receiver has received a second backward defect indicator from the client;
determining that the second receiver has received the second backward defect indicator from the client; and
based on the determinations that the first receiver and the second receiver have received the second backward defect indicator from the client, determining that an interruption has occurred in conjunction with a transmission media between the second transmitter and the client.

5. The method of claim 4, further comprising, based on the determination of the interruption between the second transmitter and the client:
waiting for a first time period; and
transmitting data from the first transmitter through the y-cable to the client and withholding transmission from the second transmitter.

6. The method of claim 5, further comprising repeating a polling operation until a termination condition is determined, wherein:
the polling operation comprises
waiting for a second time period; and
switching transmission of data through the y-cable between the first transmitter and the second transmitter; and
determining the termination condition comprises:
determining that one of the first receiver or the second receiver has received a third backward defect indicator from the client; and
determining that one of the first receiver or the second receiver has not received the third backward defect indicator from the client.

7. The method of claim 1, further comprising:
receiving a protection switching message in conjunction and the first backward defect indicator;
determining a priority between the protection switching message and the first backward defect indicator; and
based on the priority, determining whether to transmit data from the first transmitter or the second transmitter through the y-cable.

8. The method of claim 7, wherein:
the protection switching message includes a signal failure message; and
the protection switching message is prioritized over the backward defect indicator.

9. The method of claim 7, wherein:
the protection switching message includes a signal degrade message; and
the protection switching message is prioritized over the backward defect indicator.

10. The method of claim 7, wherein:
the protection switching message includes a signal degrade message; and
the backward defect indicator is prioritized over the protection switching message.

11. A network element comprising:
a first transmitter designated as an active transmitter communicatively coupled to a y-cable and a second transmitter of the network element designated as a standby transmitter communicatively coupled to the y-cable;
a selector communicatively coupled to the first transmitter and to the second transmitter and configured to selectively output data from either the first transmitter or the second transmitter through the y-cable to a client;
a first receiver configured to receive output from the client through the y-cable and a second receiver configured to receive output from the client through the y-cable; and
a switch management controller communicatively coupled to the selector, the first receiver, and the second receiver and configured to:
determine whether a first receiver has received a first backward defect indicator from the client;
determine whether a second receiver has received the first backward defect indicator from the client;
based on whether the determination regarding whether a first receiver has received the first backward defect indicator from the client and the determination whether a second receiver has received the first backward defect indicator from the client, determine that an interruption has occurred within a transmission media between the network element and the client; and
based on the determination of the interruption, cause the selector to transmit data from the second transmitter through the y-cable to the client and withhold transmission from the first transmitter.

12. The network element of claim 10, wherein the switch management controller is further configured to:
determine that the first receiver has received the first backward defect indicator;
determine that the second receiver has received the first backward defect indicator; and
based on the determinations that the first receiver and the second receiver have received the first backward defect indicator, determine that an interruption has occurred in conjunction with a transmission media between the first transmitter and the client.

13. The network element of claim 10, wherein the switch management controller is further configured to:
determine that the first receiver has not received a backward defect indicator;
determine that the second receiver has received the first backward defect indicator; and
based on the determination that the first receiver has not received the backward defect indicator and the determination that the second receiver has received the first backward defect indicator, determine that an interruption has occurred between the first transmitter and the client and between the client and the first receiver.

14. The network element of claim 10, wherein the switch management controller is further configured to, subsequent to transmitting data from the second transmitter through the y-cable to the client:
determine that the first receiver has received a second backward defect indicator from the client;
determine that the second receiver has received the second backward defect indicator from the client; and
based on the determinations that the first receiver and the second receiver have received the second backward defect indicator from the client, determine that an interruption has occurred in conjunction with a transmission media between the second transmitter and the client.

15. The network element of claim 14, wherein the switch management controller is further configured to, based on the determination of the interruption between the second transmitter and the client:
wait for a first time period; and
cause the selector to transmit data from the first transmitter through the y-cable to the client and withhold transmission from the second transmitter.

16. The network element of claim 15, wherein the switch management controller is further configured to repeating a polling operation until a termination condition is determined, wherein:
the polling operation comprises
waiting for a second time period; and
switching transmission of data through the y-cable between the first transmitter and the second transmitter; and
determining the termination condition comprises:
determining that one of the first receiver or the second receiver has received a third backward defect indicator from the client; and
determining that one of the first receiver or the second receiver has not received the third backward defect indicator from the client.

17. The network element of claim 10, wherein the switch management controller is further configured to:
receive a protection switching message in conjunction and the first backward defect indicator;
determine a priority between the protection switching message and the first backward defect indicator; and
based on the priority, determining whether to cause the selector to transmit data from the first transmitter or the second transmitter through the y-cable.

18. The network element of claim 17, wherein:
the protection switching message includes a signal failure message; and
the protection switching message is prioritized over the backward defect indicator.

19. The network element of claim 17, wherein:
the protection switching message includes a signal degrade message; and
the protection switching message is prioritized over the backward defect indicator.

20. The network element of claim 17, wherein:
the protection switching message includes a signal degrade message; and
the backward defect indicator is prioritized over the protection switching message.

21. An article of manufacture comprising:
a computer readable medium; and
computer-executable instructions carried on the computer readable medium, the instructions readable by a processor, the instructions, when read and executed, for causing the processor to:
at a network element communicatively coupled to a y-cable through a first transmitter of the network element designated as an active transmitter and a second transmitter of the network element designated as a standby transmitter, transmit data from the first transmitter through the y-cable to a client and withhold transmission from the second transmitter;
determine whether a first receiver has received a first backward defect indicator from the client;
determine whether a second receiver has received the first backward defect indicator from the client;
based on the determination regarding whether a first receiver has received the first backward defect indicator from the client and the determination whether a second receiver has received the first backward defect indicator from the client, determine that an interruption has occurred within a transmission media between the network element and the client; and
based on the determination of the interruption, transmit data from the second transmitter through the y-cable to the client and withholding transmission from the first transmitter.

22. The article of claim 21, further comprising instructions for causing the processor to:
determine that the first receiver has received the first backward defect indicator;
determine that the second receiver has received the first backward defect indicator; and
based on the determinations that the first receiver and the second receiver have received the first backward defect indicator, determine that an interruption has occurred in conjunction with a transmission media between the first transmitter and the client.

23. The article of claim 21, further comprising instructions for causing the processor to:
determine that the first receiver has not received a backward defect indicator;
determine that the second receiver has received the first backward defect indicator; and
based on the determination that the first receiver has not received the backward defect indicator and the determination that the second receiver has received the first backward defect indicator, determine that an interruption has occurred between the first transmitter and the client and between the client and the first receiver.

24. The article of claim 21, further comprising instructions for causing the processor to, subsequent to transmitting data from the second transmitter:
determine that the first receiver has received a second backward defect indicator from the client;
determine that a second receiver has received the second backward defect indicator from the client; and
based on the determinations that the first receiver and the second receiver have received the second backward defect indicator from the client, determine that an interruption has occurred in conjunction with a transmission media between the second transmitter and the client.

25. The article of claim 24, further comprising instructions for causing the processor to, based on the determination of the interruption between the second transmitter and the client:
wait for a first time period; and
transmit data from the first transmitter through the y-cable to the client and withhold transmission from the second transmitter.

26. The article of claim 25, further comprising instructions for causing the processor to repeat a polling operation until a termination condition is determined, wherein:
the polling operation comprises
waiting for a second time period; and
switching transmission of data through the y-cable between the first transmitter and the second transmitter; and
determining the termination condition comprises:
determining that one of the first receiver or the second receiver has received a third backward defect indicator from the client; and
determining that one of the first receiver or the second receiver has not received the third backward defect indicator from the client.

27. The article of claim 21, further comprising instructions for causing the processor to:
receive a protection switching message in conjunction and the first backward defect indicator;
determine a priority between the protection switching message and the first backward defect indicator; and
based on the priority, determine whether to transmit data from the first transmitter or the second transmitter through the y-cable.

28. The article of claim 27, wherein:
the protection switching message includes a signal failure message; and
the protection switching message is prioritized over the backward defect indicator.

29. The article of claim 27, wherein:
the protection switching message includes a signal degrade message; and
the protection switching message is prioritized over the backward defect indicator.

30. The article of claim 27, wherein:
the protection switching message includes a signal degrade message; and
the backward defect indicator is prioritized over the protection switching message.
